(19) United States
(12) Patent Application Publication
(10) Pub. No.: US 2025/0147751 A1
(43) Pub. Date: May 8, 2025

(54) HOME APPLIANCE

(71) Applicant: LG ELECTRONICS INC., Seoul (KR)

(72) Inventors: Heewoo Lim, Seoul (KR); Jungeun Kwon, Seoul (KR); Youngwoo Jo, Seoul (KR); Yangil Kim, Seoul (KR); Cheol Choi, Seoul (KR)

(73) Assignee: LG ELECTRONICS INC., Seoul (KR)

(21) Appl. No.: 18/934,775

(22) Filed: Nov. 1, 2024

(30) Foreign Application Priority Data
Nov. 2, 2023 (KR) 10-2023-0149670

(51) Int. Cl. G06F 8/65; G06F 3/14; G06F 9/4401; H04L 12/28

(52) U.S. Cl. CPC G06F 8/65; G06F 3/14; G06F 9/4401; H04L 12/2814

(57) ABSTRACT

A home appliance is disclosed. The home appliance of the present disclosure includes a display; a transceiver configured to receive data from an external server or a mobile terminal; a load driver configured to perform load control or safety control; a processor configured to display home a screen including information based on sensor data from a sensor device on the display, wherein the processor is configured to execute an operating system kernel, execute a hardware abstraction layer on the operating system kernel, execute a framework on the hardware abstraction layer, execute an application on the framework, display an image received from the server or the mobile terminal on the display, based on the framework, and display the information based on the sensor data on the display, based on the hardware abstraction layer and the framework.

### BACKGROUND

### 1. Field

This disclosure relates to a home appliance, and more particularly, to a home appliance capable of processing and displaying the information based on sensor data and received images separately.

### 2. Description of the Related Art

A home appliance may be an electric device used in a home, such as a washing machine, a refrigerator, and an air conditioner.

As the functions of home appliance are advanced, various functions are being added to the home appliance. To this end, a function of downloading data from an external server or the like and updating the data is required.

Meanwhile, there is a disadvantage that efficient updates cannot be performed because load control data, safety control data, firmware data, application data, etc. are mixed in a memory or processor of the home appliance. In addition, there is a disadvantage that it is difficult to perform upgrades for new functions.

In addition, there is a disadvantage that complex processing is required when displaying a home screen based on various data in the home appliance.

### SUMMARY

The disclosure has been made in view of the above problems, and may provide a home appliance capable of processing and displaying the information based on sensor data and received images separately.

Meanwhile, the disclosure may further provide a home appliance capable of operating various types of home appliances based on a common platform.

Meanwhile, the disclosure may further provide a home appliance capable of efficiently performing updates or upgrades by applying a common platform to the home appliance.

In accordance with an aspect of the present disclosure, a home appliance includes: a display; a transceiver configured to receive data from an external server or a mobile terminal; a load driver configured to perform load control or safety control; a processor configured to display a home screen including information based on sensor data from a sensor device on the display, in which the processor is configured to execute an operating system kernel, execute a hardware abstraction layer on the operating system kernel, execute a framework on the hardware abstraction layer, execute an application on the framework, display an image received from the server or the mobile terminal on the based on the framework, and display the display, information based on the sensor data on the display, based on the hardware abstraction layer and the framework.

Meanwhile, the image received from the server or the mobile terminal may include a weather information image, a clock information image, or a background image.

Meanwhile, the processor may be configured to, in a background screen display mode, display a background image received from the server or the mobile terminal, and in a home screen display mode, display the information based on the sensor data on the display.

Meanwhile, the processor may be configured to, in a home screen display mode, display the information based on the sensor data on a first area within the home screen, and display a weather information image or clock information image received from the server or the mobile terminal on a second area within the home screen.

Meanwhile, the processor may be configured to, in the framework, execute an Android open source part, an Android extension part, a home appliance common extension part, and a product extension part, separately.

Meanwhile, the processor may be configured to, in a background screen display mode, execute a server communication service within the framework, receive a background image from the server or the mobile terminal through the server communication service, and display the background image on the display through the Android extension part.

Meanwhile, the processor may be configured to, in a home screen display mode, execute a server communication service and a home screen service within the framework, receive a weather information image or a clock information image from the server or the mobile terminal through the server communication service, and display the weather information image or the clock information image on the display through the home screen service and the Android extension part.

Meanwhile, the processor may be configured to, in a home screen display mode, execute a home screen service within the framework, and display the information based on the sensor data on the display, through the hardware abstraction layer, the home screen service, and the Android extension part.

Meanwhile, the processor may be configured to, in response to receiving a remote control signal based on Infra Red (IR) signal from a remote control device, turn on the display, based on the hardware abstraction layer.

Meanwhile, the processor may be configured to, in response to receiving a remote control signal based on Infra Red (IR) signal from a remote control device, execute a home screen service within the framework, and display the home screen, based on the hardware abstraction layer and the home screen service.

Meanwhile, the processor may be configured to, in response to receiving a remote control signal Radio Frequency (RF) signal from a remote control device, execute a remote control device service and a home screen service within the framework, and display the home screen, based on the hardware abstraction layer, the remote control device service, and the home screen service.

Meanwhile, in response to receiving a remote control signal from the server or the mobile terminal, based on a server communication service executed within the framework, the processor may be configured to execute a home screen service within the framework, and display the home screen, based on the hardware abstraction layer, and the home screen service.

Meanwhile, the processor may be configured to execute a board support package including the operating system kernel, the hardware abstraction layer, and a device driver, execute the framework on the board support package, and execute an application on the framework.

Meanwhile, the processor may be further configured to execute a boot loader within the board support package.

Meanwhile, the load driver may be arranged in a first circuit, and the transceiver and the processor may be arranged in a second circuit.

Meanwhile, the load driver may be arranged in a first circuit, the transceiver may be arranged in a second circuit, the processor may be arranged in a third circuit, and the second circuit may be arranged between the first circuit and the third circuit.

Meanwhile, the load driver may be arranged in a first circuit, a second processor configured to control an operation mode may be arranged in a second circuit, the transceiver and the processor may be arranged in a third circuit, and a second circuit may be arranged between the first circuit and the third circuit.

In accordance with another aspect of the present disclosure, a home appliance includes: a display; a transceiver configured to receive data from an external server or a mobile terminal; a load driver configured to perform load control or safety control; a processor configured to display a home screen including information based on sensor data from a sensor device on the display, in which the processor is configured to execute an operating system kernel, execute a framework on the operating system kernel, execute an application on the framework, and execute an Android open source part, an Android extension part, a home appliance common extension part, and a product extension part within the framework separately.

Meanwhile, the processor may be configured to, in a background screen display mode, execute a server communication service within the framework, receive a background image from the server or the mobile terminal through the server communication service, and display the background image on the display through the Android extension part.

Meanwhile, the processor may be configured to, in a home screen display mode, execute a server communication service and a home screen service within the framework, receive a weather information image or a clock information image from the server or the mobile terminal through the server communication service, and display the weather information image or the clock information image on the display through the home screen service and the Android extension part.

### BRIEF DESCRIPTION OF THE DRAWINGS

The above and other objects, features and advantages of the present invention will be more apparent from the following detailed description in conjunction with the accompanying drawings, in which:

FIG. 1 is an example of a configuration diagram of a home appliance system including a home appliance according to an embodiment of the present disclosure;

FIGS. 2A to 2E are diagrams illustrating various examples of the home appliance of FIG. 1;

FIG. 3 is an example of an internal block diagram of a mobile terminal of FIG. 1;

FIG. 4A is an example of an internal block diagram of a home appliance according to the present disclosure;

FIGS. 4B and 4C are diagrams for explaining FIG. 4A;

FIG. 5A is an example of an internal block diagram of a home appliance according to an embodiment of the present disclosure;

FIG. 5B is another example of an internal block diagram of a home appliance according to an embodiment of the present disclosure;

FIG. 5C is another example of an internal block diagram of a home appliance according to an embodiment of the present disclosure;

FIGS. 6A to 6B are diagrams for explaining the operation of the home appliance of FIG. 5A;

FIG. 7 is a diagram illustrating an example of a platform executed on a processor in a home appliance according to an embodiment of the present disclosure;

FIG. 8 is a diagram illustrating another example of a platform executed on a processor in a home appliance according to an embodiment of the present disclosure;

FIG. 9 is a diagram illustrating an air conditioner which is an example of a home appliance according to an embodiment of the present disclosure; and

FIGS. 10 to 12B are diagrams for explaining the operation of a home appliance according to an embodiment of the present disclosure.

### DETAILED DESCRIPTION OF THE PREFERRED EMBODIMENTS

Hereinafter, the present disclosure will be described in more detail with reference to the drawings.

The suffixes such as “module” and “unit” may be used to refer to elements or components. Use of such suffixes herein is merely intended to facilitate description of the specification, and the suffixes do not have any special meaning or function. Accordingly, the terms “module” and “unit” may be used interchangeably.

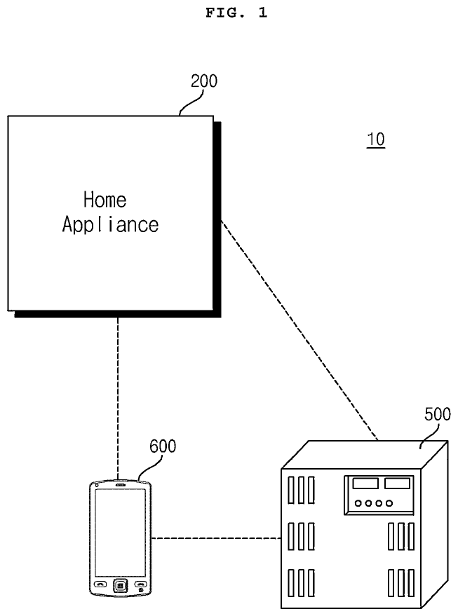

FIG. 1 is an example of a configuration diagram of a home appliance system including a home appliance according to an embodiment of the present disclosure.

Referring to FIG. 1, a home appliance system 10 according to an embodiment of the present disclosure may include a home appliance 200, a mobile terminal 600, and a server 500.

In addition, the home appliance system 10 may further include an access point (AP) device (not shown) for connecting the home appliance 200 to an external network.

The home appliance 200 includes a motor, a magnetron, or a heater for load control and the like.

Meanwhile, the home appliance 200 may include an inverter to convert DC power into AC power for efficient load control.

Meanwhile, the home appliance 200 may be configured to execute a system application, an application related to an operation mode, or a download application therein.

Meanwhile, the mobile terminal 600 may perform wireless communication with the home appliance 200 to remotely control the wirelessly connected home appliance 200, or to receive monitoring data from the home appliance 200.

Meanwhile, the server 500 may provide data to the home appliance 200 connected through a network or the like.

For example, the server 500 may provide update information to the home appliance 200 in response to a request of the mobile terminal 600.

As another example, the server 500 may provide update information to the home appliance 200 when necessary, even when there is no request from the mobile terminal 600 or the home appliance 200.

Meanwhile, the update information may include firmware update information, software update information, and the like.

The firmware update information is data for updating the firmware inside the home appliance 200, and may be, for example, update information for load control or safety control of the home appliance 200.

Meanwhile, the software update information may include upgrade information related to a new operation mode. Based on the upgrade information related to the new operation mode, the operation mode may be upgraded.

Meanwhile, the software update information may further include update information on a system application, an application related to an operation mode, or a download application. Based on such update information, an update of the operation mode may be performed.

The firmware update information may include date data for firmware, an operating system, or a framework. Based on the firmware update information, the firmware may be updated.

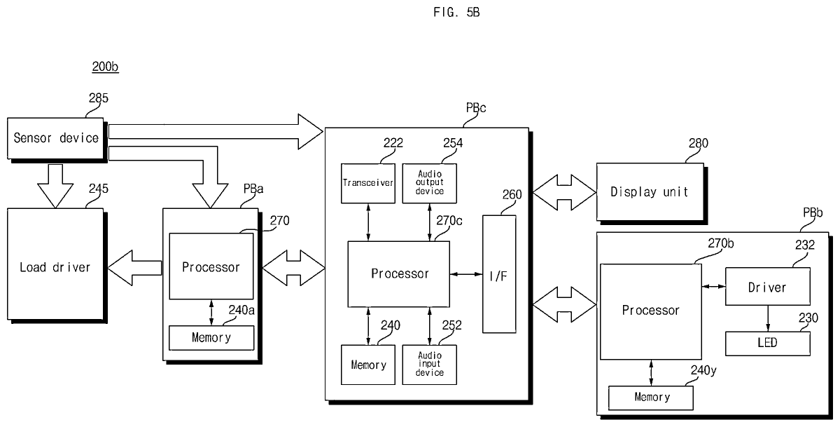

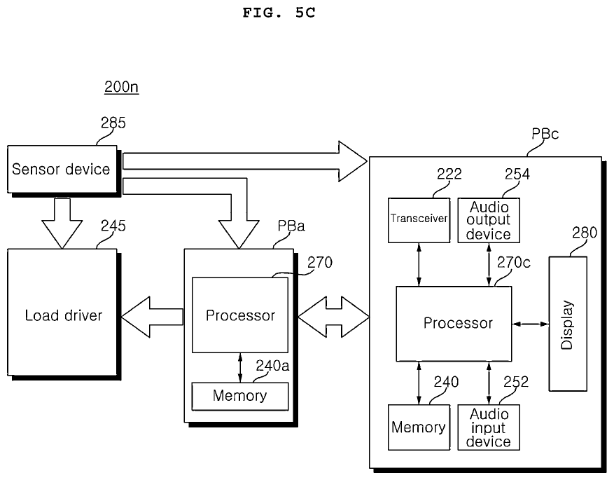

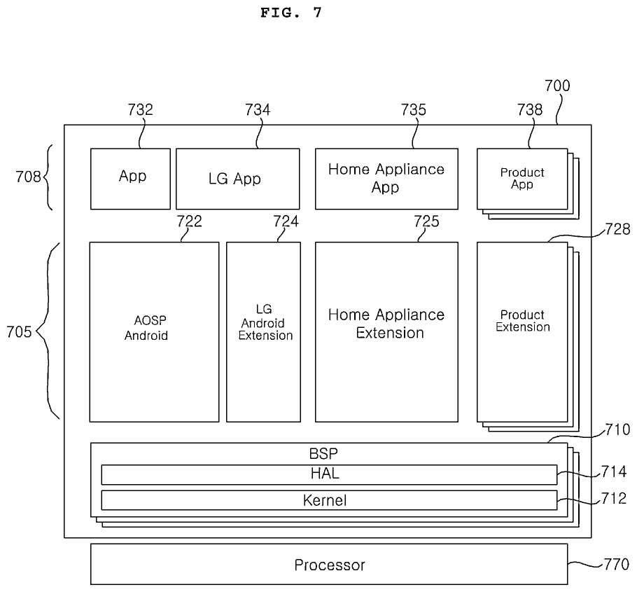

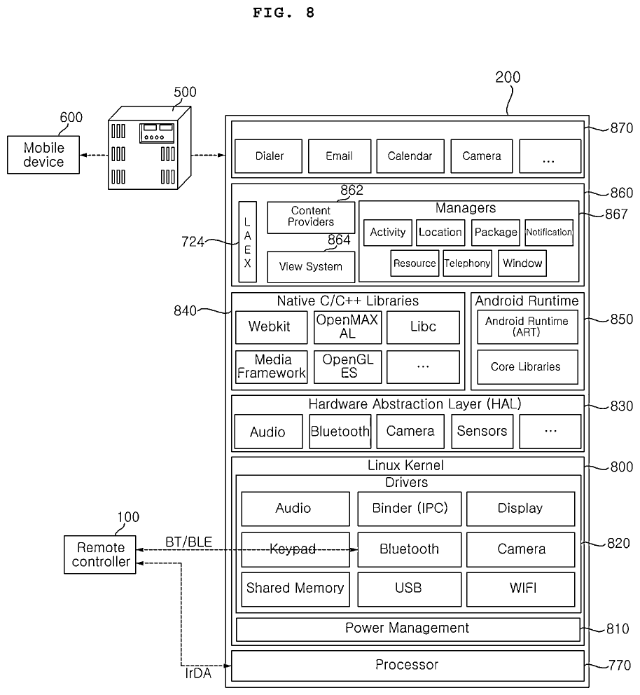

The home appliance 200 according to an embodiment of the present disclosure includes a display (280 of FIG. 5A), a transceiver (222 of FIG. 5A) that receives data from an external server 500 or a mobile terminal 600, a load driver (245 of FIG. 5A) that performs load control or safety control, and a processor (770 of FIG. 7) that controls a home screen including information based on sensor data from a sensor device 285 to be displayed on the display 280.

Meanwhile, the processor 770 executes an operating system kernel (712 of FIG. 7), executes a hardware abstraction layer (714 of FIG. 7) on the operating system kernel 712, executes a framework (705 of FIG. 7) on the hardware abstraction layer 714, and executes an application (708 of FIG. 7) on the framework 705.

Meanwhile, the processor 770 display an image received from a server 500 or a mobile terminal 600 on the display 280, based on the framework 705, and display the information based on sensor data on the display 280, based on the hardware abstraction layer 714 and the framework 705.

Accordingly, the information based on sensor data and received images may be processed and displayed separately. Accordingly, a background screen or a home screen may be simply displayed.

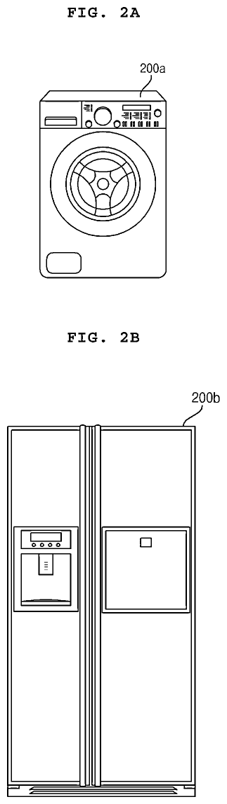

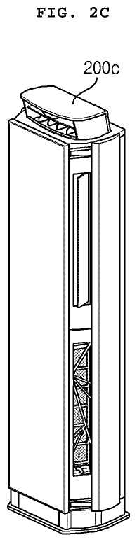

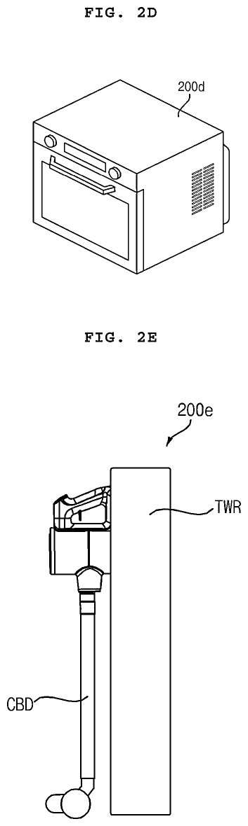

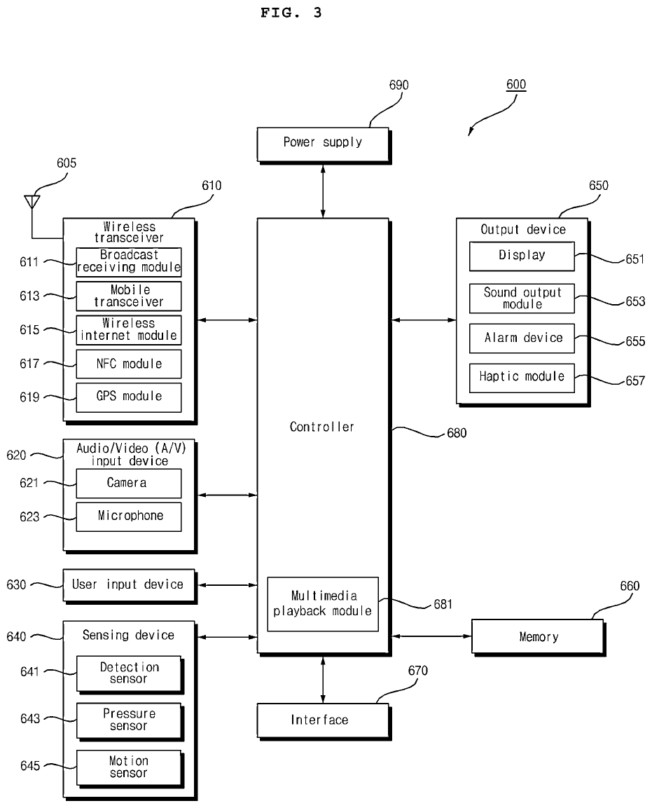

Meanwhile, various examples of the home appliance 200 applied in the present disclosure are possible. This is exemplified through FIGS. 2A to 2E.

FIGS. 2A to 2E are diagrams illustrating various examples of the home appliance of FIG. 1.

FIG. 2A illustrates a washing machine 200a as an example of a home appliance.

When the home appliance 200 is the washing machine 200a, the washing machine 200a may include a washing tub motor (not shown) and an inverter (not shown) for rotating the washing tub motor so as to rotate a washing tub.

FIG. 2B illustrates a refrigerator 200b as an example of a home appliance.

When the home appliance 200 is the refrigerator 200b, the refrigerator 200b may include a compressor (not shown), a compressor motor (not shown) for operation of the compressor, and an inverter (not shown) for controlling the compressor motor so as to supply cold air into the refrigerator.

FIG. 2C illustrates an air conditioner 200c as an example of a home appliance.

When the home appliance 200 is the air conditioner 200c, the air conditioner 200c may include a compressor (not shown), a compressor motor (not shown) for operation of the compressor, and an inverter (not shown) for controlling the compressor motor so as to supply cold air from the air conditioner.

FIG. 2D illustrates a cooking appliance 200d as an example of a home appliance.

When the home appliance 200 is the cooking appliance 200d, the cooking appliance 200d may include a magnetron (not shown) or a light wave heater (not shown) and an inverter (not shown) for controlling the magnetron or light wave heater so as to heat foods in the cooking appliance.

FIG. 2E illustrates a cleaner 200e as an example of a home appliance.

When the home appliance 200 is the cleaner 200e, the cleaner 200e may include a fan motor (not shown) and an inverter (not shown) for controlling the fan motor so as to suck foreign substances inside the cooking appliance.

Meanwhile, according to an embodiment of the present disclosure, various examples of the home appliance 200 such as a washing machine 200a, a refrigerator 200b, an air conditioner 200c, a cooking appliance 200d, and a cleaner 200e, as well as a dryer, a clothes manager, a robot cleaner, and an air purifier, are possible.

FIG. 3 is an internal block diagram of the mobile terminal of FIG. 1.

Referring to FIG. 3, the mobile terminal 600 may include a wireless transceiver 610, an audio/video (A/V) input device 620, a user input device 630, a sensing device 640, an output device 650, a memory 660, an interface670, a controller 680, and a power supply 690.

Meanwhile, the wireless transceiver 610 may include a broadcast receiving module 611, a mobile transceiver 613, a wireless Internet module 615, an NFC module 617, and a GPS module 619.

The broadcast receiving module 611 may receive at least one of a broadcast signal or broadcast related information from an external broadcast management server through a broadcast channel. In this case, the broadcast channel may include a satellite channel, a terrestrial channel, and the like.

The broadcast signal and/or broadcast related information received through the broadcast receiving module 611 may be stored in the memory 660.

The mobile transceiver 613 may transmit/receive a wireless signal to and from at least one of a base station, an external terminal, or a server on a mobile communication network. Here, the wireless signal may include a voice call signal, a video call signal, or various types of data according to text/multimedia message transmission/reception.

The wireless Internet module 615 refers to a module for wireless Internet access, and the wireless Internet module 615 may be built-in the mobile terminal 600 or may be externally provided to the mobile terminal. For example, the wireless Internet module 615 may perform WiFi-based wireless communication or WiFi Direct-based wireless communication.

The NFC module 617 perform near field communication. The NFC module 617 may receive data from a corresponding home appliance or transmit data to the corresponding home appliance, when it approaches within a certain distance from a NFC tag or a home appliance in which the NFC module is mounted, that is, when tagging is performed.

In addition, Bluetooth, Radio Frequency Identification (RFID), infrared data association (IrDA), Ultra Wideband (UWB), ZigBee, and the like may be used as a short-range communication technology.

The Global Position System (GPS) module 619 may receive location information from a plurality of GPS satellites.

The Audio/Video (A/V) input device 620 is for inputting an audio signal or a video signal, and may include a camera 621, a microphone 623, and the like.

The user input device 630 generates key input data input by a user to control the operation of the terminal. To this end, the user input device 630 may include a key pad, a dome switch, a touch pad (pressure/capacitance), and the like. In particular, when the touch pad forms a mutual layer structure with the display 651, it may be referred to as a touch screen.

The sensing device 640 may generate a sensing signal for controlling the operation of the mobile terminal 600 by detecting the current state of the mobile terminal 600, such as the open/closed state of the mobile terminal 600, the location of the mobile terminal 600, and the contact of user.

The sensing device 640 may include a detection sensor 641, a pressure sensor 643, and a motion sensor 645. The motion sensor 645 may detect the movement or location of the mobile terminal 600 by using an acceleration sensor, a gyro sensor, a gravity sensor, or the like. In particular, the gyro sensor is a sensor for measuring angular velocity, and may detect a direction (angle) that is turned with respect to a reference direction.

The output device 650 may include a display 651, a sound output module 653, an alarm device 655, and a haptic module 657.

The display 651 displays and outputs information processed by the mobile terminal 600.

Meanwhile, as described above, when the display 651 and the touchpad form a mutual layer structure to configure a touch screen, the display 651 can also be used as an input device capable of inputting information by a user's touch in addition to the output device. The sound output module 653 outputs audio data that is received from the wireless transceiver 610 or stored in the memory 660. Such a sound output module 653 may include a speaker, a buzzer, and the like.

The alarm device 655 outputs a signal for notifying the occurrence of an event in the mobile terminal 600. For example, the signal may be output in the form of vibration.

The haptic module 657 generates various tactile effects that a user can feel. A representative example of the tactile effect generated by the haptic module 657 is a vibration effect.

The memory 660 may store a program for processing and controlling the controller 680, and may serve to temporarily store the input or output data (e.g. phone book, message, still image, video, etc.).

The interface670 may serve as an interface with all external devices connected to the mobile terminal 600. The interface670 may receive data or receive power from such an external device and transmit it to each component inside the mobile terminal 600, and may allow the data inside the mobile terminal 600 to be transmitted to an external device.

The controller 680 may generally control the overall operation of the mobile terminal 600 by controlling the operation of each of the above units.

For example, it may perform related control and processing for voice call, data communication, video call, and the like. In addition, the controller 680 may include a multimedia playback module 681 for multimedia playback. The multimedia playback module 681 may be configured as hardware in the controller 680 or may be configured as software separately from the controller 680.

The power supply 690 may receive external power and internal power under the control of the controller 680 to supply power necessary for the operation of each component.

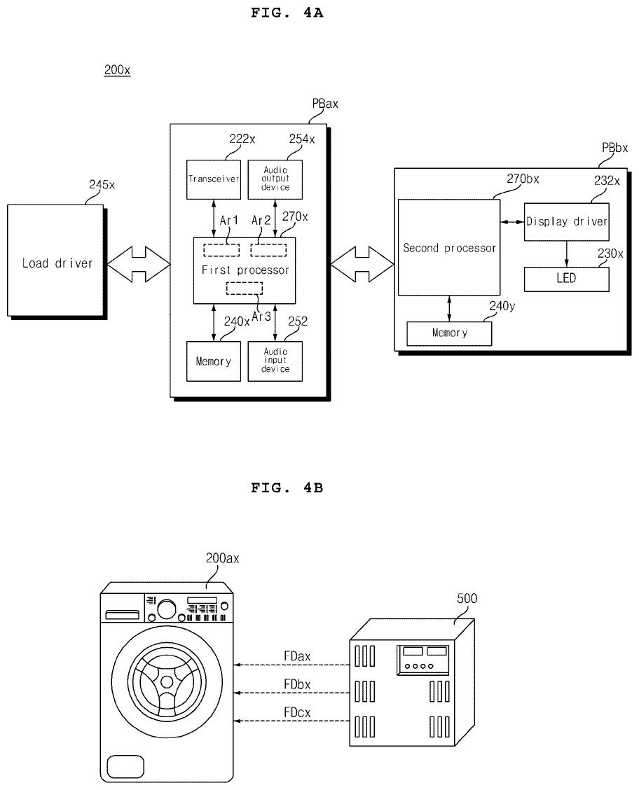

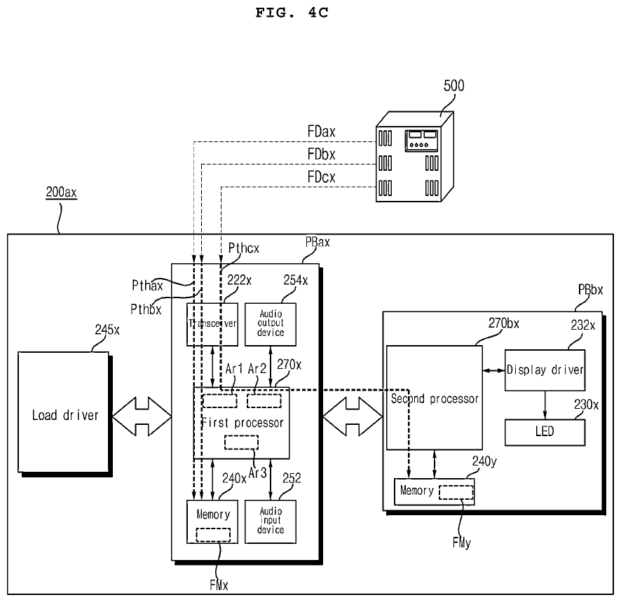

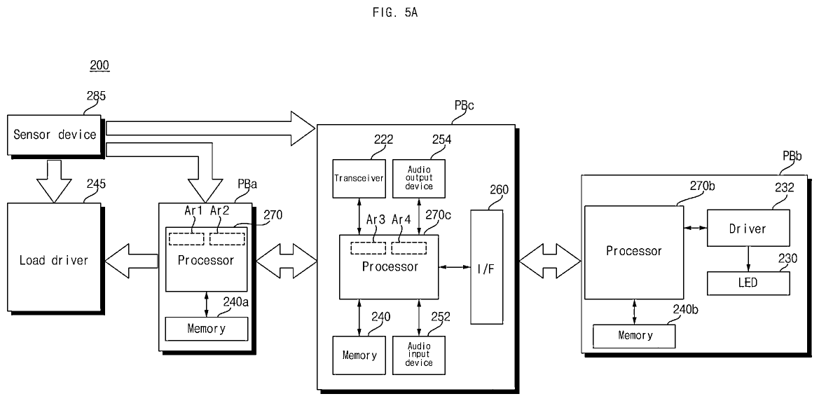

FIG. 4A is an example of an internal block diagram of a home appliance according to the present disclosure.

Referring to FIG. 4A, the home appliance 200x according to the present disclosure includes a first circuit PBax for load control or safety control, and a second circuit PBbx for light emitting diode control.

Meanwhile, the first circuit PBax may output a load control signal or a safety control signal to a load driver 245x that operates to drive a load such as a motor or a magnetron.

The first circuit PBax may include a memory 240x for storing data related to a load control signal or a safety control signal, a first processor 270x for outputting the load control signal or the safety control signal, a transceiver 222x for performing communication with an external mobile terminal 600 or a server 500, an audio output device 254x for outputting audio, and an audio input device 252 for collecting audio.

Meanwhile, the second circuit PBbx is connected to the first circuit PBax by wire or wirelessly, and may include a second processor 270bx for outputting a light emitting diode control signal from the first circuit PBax, in particular, based on a control signal from the first processor 270x, a memory 240y for storing data related to the light emitting diode control signal, a display driver 232x for outputting a light emitting diode driving signal based on the light emitting diode control signal, and a light emitting diode 230x for emitting light based on the light emitting diode driving signal. According to the home appliance 200x related to the present disclosure, all of firmware, data related to load control or safety control, system application, application related to operation mode, download application, etc. are stored in the memory 240x inside the first circuit PBax.

Meanwhile, when data update is required in the memory 240x, there must be a free space in the memory 240x, and an address in which data is stored must also be identified.

However, since various data are mixed inside the memory 240x inside the first circuit PBax, there is a disadvantage in that it is difficult to efficiently perform data update.

For example, when some data in the memory 240x need to be updated, for example, when an application needs to be updated, there is a disadvantage in that all data stored in the memory 240x needs to be updated. In addition, there is a disadvantage in that it is difficult to perform the upgrade of the new operation mode.

Meanwhile, although the first processor 270x in the first circuit PBax is the main processor of the home appliance 200x, since it operates based on firmware rather than on the operating system OS, there is a disadvantage in that the processing speed is slow in comparison with the operating system (OS)-based processing.

FIGS. 4B and 4C are diagrams for explaining FIG. 4A.

First, FIG. 4B illustrates that the server 500 transmits various data FDax, FDbx, FDcx to the home appliance 200x.

For example, among the various data FDax, FDbx, FDcx received from the server 500, a first data FDax may be firmware update information or load control update information, a second data FDbx may be an application update information, and a third data FDcx may be display update information.

Next, FIG. 4C is a diagram illustrating movement path of various data FDax, FDbx, FDcx received in the home appliance 200x.

Referring to FIG. 4C, when the home appliance 200x receives first data FDax that is firmware update information or load control update information, the first data FDax may be stored in the memory 240x, via the transceiver 222x and the first processor 270x, according to a first path Pthax.

Meanwhile, when the home appliance 200x receives the second data FDbx which is application update information, the second data FDbx may be stored in the memory 240x, via the transceiver 222x and the first processor 270x, according to a second path Pthbx.

Meanwhile, the first processor 270x may be configured to execute a firmware in an internal first area Ara, execute a firmware-based application in an internal second area Arb, and execute a firmware-based load control or safety control in an internal third area Arc.

Meanwhile, when the home appliance 200x receives the third data FDcx which is display update information, the third data FDcx may be stored in the memory 240y, via the transceiver 222x, the first processor 270x, and the second processor 270bx, according to a third path Pthcx.

As shown in the drawing, since the first data FDax that is firmware update information or load control update information and the second data FDbx that is application update information are all stored in the same memory, i.e., in the memory 240x, there is a disadvantage in that it is difficult to efficiently perform data update.

For example, when some data in the memory 240x need to be updated, in particular, when an application needs to be updated, there is a disadvantage in that all data stored in the memory 240x needs to be updated. Furthermore, there is a disadvantage in that it is difficult to upgrade the new operation mode.

Accordingly, the present disclosure suggests a method for efficiently performing the upgrade by separating the load control and the operation mode control. In addition, a method for efficiently performing firmware update or operation mode upgrade by separating the load control driven based on the firmware and the operation mode control executed based on the operating system is suggested. This will be described with reference to FIG. 5A and below.

FIG. 5A is an example of an internal block diagram of a home appliance according to an embodiment of the present disclosure.

Referring to FIG. 5A, the home appliance 200 according to an embodiment of the present disclosure includes a first circuit PBa including a first processor 270 for load control or safety control, and a second circuit PBc that is connected to the first circuit PBa by wire or wirelessly, and includes a second processor 270c which controls an operation mode based on the operating system 710, and performs an upgrade based on the upgrade information received from the external server 500 or the mobile terminal 600.

Specifically, when a hardware device is additionally mounted on the home appliance 200, the second processor 270c may receive upgrade information related to a new operation mode using an additionally mounted hardware device from the external server 500 or the mobile terminal 600, and may perform an upgrade for the new operation mode, based on the upgrade information related to the new operation mode.

For example, when the home appliance 200 is the washing machine 200a and an automatic detergent input device (not shown) is additionally mounted in the washing machine 200a, the second processor 270c in the washing machine 200a may receive upgrade information related to a new washing machine operation mode in which an automatic detergent input mode is set in relation to the automatic detergent input device (not shown), and may perform an upgrade for the new washing machine operation mode, based on the upgrade information related to the new washing machine operation mode.

As another example, when the home appliance 200 is the washing machine 200a, and a new sensor device 285 including a spectral sensor, an acceleration sensor, a gyro sensor, a turbidity sensor, and a humidity sensor is input to the washing machine 200a, the second processor 270c in the washing machine 200a receives upgrade information related to a new washing machine operation mode operable based on various sensor information sensed by a sensor device 285, and may perform an upgrade for a new washing machine operation mode, based on the upgrade information related to the new washing machine operation mode.

As another example, when the home appliance 200 is an air conditioner 200c, and a new sensor device 285 including a spectral sensor, an acceleration sensor, a gyro sensor, a dust sensor, a gas sensor, and a humidity sensor is disposed around the air conditioner 200c, the second processor 270c in the air conditioner 200c may receive upgrade information related to a new air conditioner operation mode operable based on various sensor information sensed by a sensor device 285, and may perform an upgrade for the new air conditioner operation mode, based on the upgrade information related to the new air conditioner operation mode.

Meanwhile, even if the home appliance 200 is not additionally equipped with a hardware device, when the upgrade information related to a new operation mode in software is received from the external server 500 or the mobile terminal 600, the second processor 270c may perform an upgrade for the new operation mode based on the upgrade information related to the new operation mode.

For example, when the home appliance 200 is the refrigerator 200b and a new rapid cooling operation mode is generated in software, the second processor 270c in the refrigerator 200b may receive upgrade information related to the new rapid cooling operation mode, and perform an upgrade for the new rapid cooling operation mode, based on the upgrade information related to the new rapid cooling operation mode.

As another example, when the home appliance 200 is the cooking appliance 200d and a new rapid thawing operation mode is generated in software, the second processor 270c in the cooking appliance 200d may receive upgrade information related to the new rapid thawing operation mode, and perform an upgrade for the new rapid thawing operation mode, based on the upgrade information related to the new rapid thawing operation mode.

As another example, when the home appliance 200 is the cleaner 200e and a new motor speed variable operation mode is generated in software, the second processor 270c in the cleaner 200e may receive upgrade information related to the new motor speed variable operation mode, and may perform an upgrade for the new motor speed variable operation mode, based on the upgrade information related to the new motor speed variable operation mode.

Accordingly, the home appliance 200 according to an embodiment of the present disclosure may be called as an upgradable home appliance that may be upgraded to a new operation mode, based on a change in hardware or software.

Meanwhile, the home appliance 200 according to an embodiment of the present disclosure may perform an update related to a setting change for an existing operation mode, in addition to an upgrade for a new operation mode.

In this specification, it is described that the upgrade of the operation mode means that a new operation mode is generated to be installed or executed, and the update of the operation mode means that setting or data change is performed for the existing operation mode.

Meanwhile, the home appliance 200 according to an embodiment of the present disclosure may further include a third circuit PBb having a third processor 270b for controlling the light emitting diode 230 or the display 280. Accordingly, the light emitting diode 230 or the display 280 may be controlled through a separate third circuit PBb.

Meanwhile, the first circuit PBa may output a load control signal or a safety control signal to a load driver 245 that operates to drive a load such as a motor or a magnetron.

The load control signal may be divided into a main load control signal for controlling a load, which is a component having the largest power consumption, and a sub load control signal for controlling other components.

For example, the main load may be a washing machine motor in the case of the washing machine 200a, may be a compressor motor in the case of the refrigerator 200b and the air conditioner 200c, may be a magnetron or a light wave heater in the case of the cooking appliance 200d, and may be a fan motor in the case of the cleaner 200e.

Meanwhile, the sub-load may be a steam device or a fan motor in the case of the washing machine 200a, may be a fan motor or a defrost heater in the case of the refrigerator 200b and the air conditioner 200c, and may be a fan motor in the case of the cooking appliance 200d.

Meanwhile, the safety control signal may be a door lock control signal or a shutdown control signal for preventing overheating of motor, in the case of the washing machine 200a, may be a shutdown control signal for preventing overheating of motor, in the case of the refrigerator 200b and the air conditioner 200c, may be a shutdown control signal for preventing overheating of a magnetron or light wave heater, in the case of the cooking appliance 200d, and may be a shutdown control signal for preventing overheating of motor, in the case of the cleaner 200e.

Meanwhile, the first circuit PBa is connected to the second circuit PBc by wire or wirelessly, and may output a load control signal or a safety control signal, based on a control signal from the second circuit PBc, in particular, from the second processor 270c.

Meanwhile, the first circuit PBa includes a first processor 270 that outputs a load control signal or a safety control signal, and a memory 240a that stores data related to the load control signal or the safety control signal.

Meanwhile, the first processor 270 may output an inverter control signal or an inverter command signal for load control, particularly, for main load control. Accordingly, the load control or safety control may be directly or indirectly performed by using the first processor 270 separated from the second processor 270c.

For example, when the home appliance 200 is the washing machine 200a, the first processor 270 in the washing machine 200a may output an inverter control signal or an inverter speed command signal for rotation of the washing machine motor.

As another example, when the home appliance 200 is the refrigerator 200b, the first processor 270 in the refrigerator 200b may output an inverter control signal or an inverter speed command signal for rotation of the compressor motor.

As another example, when the home appliance 200 is the air conditioner 200c, the first processor 270 in the air conditioner 200c may output an inverter control signal or an inverter speed command signal for rotation of the compressor motor.

As another example, when the home appliance 200 is the cooking appliance 200d, the first processor 270 in the cooking appliance 200d may output an inverter control signal for controlling a magnetron or a light wave heater.

Meanwhile, a sensor device 285 including a temperature sensor and a current sensor may transmit current information to the load driver 245 or the first circuit PBa, and transmit temperature information or the like to the second circuit PBC.

Accordingly, the first circuit PBa may perform load control or safety control based on current information or the like, and the second circuit PBc may generate an operation mode control signal based on temperature information or the like.

Meanwhile, the sensor device 285 may further include a camera or the like, an image signal from the camera or the like may be transmitted to the second circuit PBc, and the second circuit PBc may generate an operation mode control signal based on the image signal from the camera or the like.

Meanwhile, the sensor device 285 is a separate device provided with a plurality of sensors, and may include a spectral sensor, an acceleration sensor, a gyro sensor, a turbidity sensor, and a humidity sensor, and signals sensed by the plurality of sensors may be transmitted to the second circuit PBc, and the second circuit PBc may generate an operation mode control signal based on the plurality of sensing signals.

Meanwhile, the sensor device 285 is a separate device provided with a plurality of sensors, and may include a spectral sensor, an acceleration sensor, a gyro sensor, a dust sensor, a gas sensor, and a humidity sensor, signals sensed by the plurality of sensors may be transmitted to the second circuit PBc, and the second circuit PBc may generate an operation mode control signal, based on a plurality of sensing signals.

Meanwhile, the third circuit PBb is connected to the second circuit PBc by wire or wirelessly, and may include a third processor 270b that controls the display 280, based on a signal from the second circuit PBC, particularly, from the second processor 270c, a memory 240b that stores data related to the display 280, and a transceiver 2230 that exchanges data with the second circuit PBc or an external server 500 or a mobile terminal 600.

At this time, the display 280 may be an LCD display, an LED display, an OLED display, etc.

The second circuit PBc may be disposed between the first circuit PBa and the third circuit PBb, and may be accessed to the first circuit PBa and the third circuit PBb by wire or wirelessly.

The second circuit PBc may include a second processor 270c for performing an operation mode control, based on the operating system 710 of the home appliance 200, a memory 240 for storing data for the operating system 710 and the operation mode control, and a transceiver 222 for performing communication with the external mobile terminal 600 or server 500.

Meanwhile, the second circuit PBc may further include an audio output unit 25 for outputting audio, an audio input unit 252 for collecting audio, and an interface 260 for inter-processor communication IOC with the first circuit PBa or the third circuit PBb.

Meanwhile, the second circuit PBc includes a transceiver 222 for performing wireless communication with the server 500 or the mobile terminal 600, so that an external data may be received or data may be transmitted to the outside through the second circuit PBc.

According to the home appliance 200 of FIG. 5A, data related to firmware, load control, or safety control may be stored in the memory 240a inside the first circuit PBa, and an operating system OS, a system application, an application related to an operation mode, a download application, and the like may be stored in the memory 240 inside the second circuit PBc.

That is, unlike FIG. 4A, firmware, data related to load control or safety control, and an operating system OS, a system application, an application related to an operation mode, a download application, and the like are separately stored.

That is, based on the update information received through the transceiver 222 performing wireless communication with the mobile terminal 600, the update of data related to load control or safety control, and the update of the operating system OS, system application, application related to an operation modes, and download application may be separately performed.

Accordingly, the upgrade of the operation mode may be efficiently performed by separating the load control and the operation mode control. Specifically, the update of firmware or the upgrade of operation mode may be efficiently performed by separating the load control driven based on the firmware and the operation mode control executed based on the operating system 710. In particular, an update related to the operation mode may be easily and efficiently performed. In addition, the operating system 710 executed in the second processor 270c may be updated.

For example, when an application in the memory 240 needs to be updated, only a corresponding application among data stored in the memory 240 may be updated, thereby efficiently performing an update.

Meanwhile, unlike FIG. 4A, since the second processor 270c inside the second circuit PBc operates as a main processor of the home appliance 200, while operating based on the operating system OS rather than on the firmware, there is an advantage in that the operating system (OS)-based processing speed is considerably faster than the firmware-based processing.

Meanwhile, it is preferable that the processing speed of the second processor 270c is higher than that of the first processor 270 or the third processor 270b. Accordingly, the operation mode control executed based on the operating system 710 may be efficiently performed.

Meanwhile, the first circuit PBa or the third circuit PBb may perform a remote procedure call communication with the second circuit PBc, which is an example of inter-processor communication (IPC).

That is, the second processor 270c in the second circuit PBc may perform a remote procedure call communication with the second circuit PBc, which is an example of inter-processor communication (IPC) with the first processor 270 in the first circuit PBa or the third processor 270b in the third circuit PBb. Thus, an efficient communication may be performed by using inter-processor communication (IPC).

Meanwhile, it is preferable that the memory 240 of the second circuit PBc in FIG. 5A has a larger storage space than the storage space of the memory 240a of the first circuit PBa or the memory 240b of the third circuit PBb.

Accordingly, among the update information received from the transceiver 222, update information to be transferred to the memory 240a of the first circuit PBa or the memory 240b of the third circuit PBb, not to the memory 240 of the second circuit PBc may be temporarily stored by the memory 240 of the second circuit PBc, and then transferred to the memory 240a of the first circuit PBa or the memory 240b of the third circuit PBb. Accordingly, the update may be efficiently performed.

Meanwhile, according to FIG. 5A, a home appliance 200m according to an embodiment of the present disclosure may include a first circuit PBa including a sensor device 285, a load driver 245, a first processor 270, etc., a second circuit PBc including a communication unit 222, a second processor 270c, etc., and a third circuit PBb including a communication unit 223, a third processor 270b, a display 280, etc.

FIG. 5B is another example of the present disclosure.

Referring to FIG. 5B, the home appliance 200m according to an embodiment of the present disclosure is similar to the home appliance 200 of FIG. 5A, but there is a difference in that the display 280 is controlled by the second processor 270c in the second circuit PBc, not by the third processor 270b in the third circuit PBb.

That is, the home appliance 200m according to an embodiment of the present disclosure may include a first circuit PBa including a sensor device 285, a load driver 245, a first processor 270, etc., a second circuit PBc including a communication unit 222 and a second processor 270c, etc., a third circuit PBb including a communication unit 223 and a third processor 270b, etc., and a display 280.

Hereinafter, only the differences from FIG. 5a will be described.

Meanwhile, the third circuit PBb may be accessed to the second circuit PBc by wire or wirelessly, and may include a third processor 270b that outputs a light-emitting diode control signal, based on a control signal from the second circuit PBc, particularly from the second processor 270c, a memory 240b that stores data related to the light-emitting diode control signal, a display driver 232 that outputs a light-emitting diode driving signal based on the light-emitting diode control signal, and a light-emitting diode 230 that emits light based on the light-emitting diode driving signal.

FIG. 5C is another example of an internal block diagram of a home appliance according to an embodiment of the present disclosure.

Referring to FIG. 5C, a home appliance 200n according to an embodiment of the present disclosure is similar to the home appliance 200 of FIG. 5A, but has a difference in that the display 280 is arranged in the second circuit PBc and the third circuit PBb is omitted. That is, a home appliance 200m according to an embodiment of the present disclosure may include a first circuit PBa including a sensor device 285, a load driver 245, a first processor 270, etc., and a second circuit PBC including a communication unit 222, a second processor 270c, a display 280, etc.

Hereinafter, only the differences from FIG. 5A will be described.

Meanwhile, the display 280 may be controlled by the second processor 270c in the second circuit PBc.

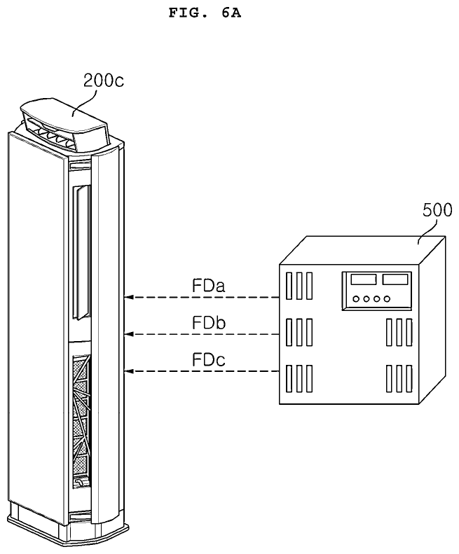

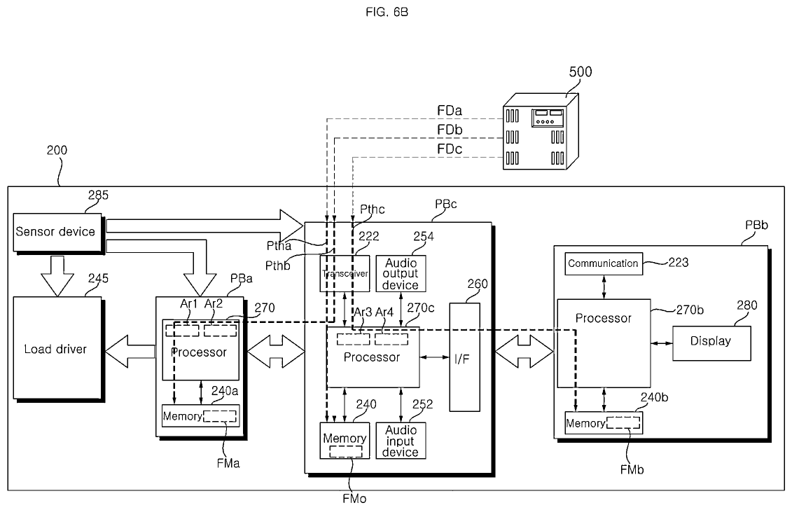

FIGS. 6A and 6B are diagrams for explaining the operation of the home appliance of FIG. 5A.

First, FIG. 6A illustrates that the server 500 transmits various data FDax, FDbx, FDc to an air conditioner 200c which is an example of the home appliance 200.

For example, among the various data FDax, FDbx, FDc received from the server 500, a first data FDa may be firmware update information or load control update information, and a second data FDb may be an application update information, and a third data FDc may be display update information.

Next, FIG. 6B is a diagram illustrating movement path of various data FDax, FDbx, FDc received by the home appliance 200.

Referring to the drawing, when the home appliance 200 receives first data FDa that is firmware update information or load control update information, the first data FDa may be stored in the memory 240a inside the first circuit PBa, via the transceiver 222 and the second processor 270c inside the second circuit PBc, and the first processor 270 inside the first circuit PBa, according to a first path Ptha.

Meanwhile, the first processor 270 inside the first circuit PBa may be configured to execute the firmware in the internal first area Ara, and execute the firmware-based load control or safety control in the internal second area Arb.

Meanwhile, when the home appliance 200 receives the second data FDb as application update information, the second data FDb may be stored in the memory 240 inside the second circuit PBc via the transceiver 222 and the second processor 270c inside the second circuit PBC according to a second path Pthb.

Similarly, when the home appliance 200 receives the operating system update information or the framework update information, the operating system update information or the framework update information may be stored in the memory 240 inside the second circuit PBC, via the transceiver 222 and the second processor 270c inside the second circuit PBc, according to the second path Pthb.

Meanwhile, when the home appliance 200 receives the third data FDc that is display update information, the third data FDc may be stored in the memory 240y inside the third circuit PBb, via the transceiver, the second processor 270c inside the second circuit PBc, and the third processor 27b inside the third circuit PBb, according to a third path Pthc 222.

As shown in the drawing, the first data FDa, which is firmware update information or load control update information, is stored in the memory 240a inside the application update first circuit PBa, and the information is separately stored in the memory 240 inside the second circuit PBc, so that data update may be performed efficiently.

In particular, the update of data stored in the memory 240 inside the second circuit PBc may be performed efficiently and frequently.

For example, when an application inside the memory 240 needs to be updated, only the application in the memory 240 inside the second circuit PBc, not the entire memory 240x of FIG. 4C, may be selectively updated, so that update may be performed efficiently.

In addition, the application may be updated during the operation mode of the home appliance 200, by separately storing application data in the memory 240 inside the second circuit PBc. Accordingly, the application update may be performed immediately.

Meanwhile, the firmware for load control or safety control is stored in a partial area Fma of the memory 240a in the first circuit PBa, the firmware for display control is stored in a partial area Fmb of the memory 240b in the third circuit PBb, and the operating system 710 and the like are stored in a partial area FMo of the memory 240 in the second circuit PBc, thereby efficiently performing firmware update or operation mode upgrade by separating the load control driven based on the firmware and the operation mode control executed based on the operating system 710.

FIG. 7 is a diagram illustrating an example of a platform executed on a processor within a home appliance according to an embodiment of the present disclosure.

Referring to FIG. 7A, the processor 770 within the home appliance 200 according to an embodiment of the present disclosure is configured to execute an operating system kernel 712, execute a hardware abstraction layer (HAL) 714 on the operating system kernel 712, execute a framework 705 on the hardware abstraction layer 714, and execute an application 708 on the framework 705.

For example, the processor 770 may be configured to execute a board support package (BSP) 710 including an operating system kernel 712, a hardware abstraction layer 714, and a device driver (820 of FIG. 8).

Meanwhile, the framework 705 may be executed on the board support package 710, and the application 708 may be executed on the framework 705. Accordingly, the information based on sensor data and received images may be processed and displayed separately.

Meanwhile, the operating system kernel 712 may be a Linux-based operating system kernel or an Android-based operating system kernel.

Meanwhile, the processor 770 can further execute a boot loader within the board support package 710. Accordingly, rapid booting is enabled.

Meanwhile, the processor 770 may be configured to display, based on the framework 705, an image received from the server 500 or the mobile terminal 600 on the display 280, and, based on the hardware abstraction layer 714 and the framework 705, display the information based on sensor data on the display 280.

Accordingly, the information based on sensor data and received images may be processed and displayed separately. Accordingly, it is possible to simply display a background screen or a home screen 1020.

Meanwhile, the image received from the server 500 or the mobile terminal 600 may include a weather information image, a clock information image, or a background image. Accordingly, the information based on sensor data and the received image may be processed and displayed separately.

Meanwhile, the framework 705 may include an Android open source part 722, an Android extension part 724, a home appliance common extension part 725, and a product extension part 728, within the framework 705.

That is, the processor 770 may be configured to execute the Android open source part 722, the Android extension part 724, the home appliance common extension part 725, and the product extension part 728 separately, within the framework 705.

The Android open source part 722 may correspond to a framework based on the Android open source.

The Android extension part 724 may be separated from the Android open source part 722, and may be utilized when displaying a background image, a weather information image, or a clock information image.

In particular, the processor 770 does not utilize the Android open source part 722, but utilizes the Android extension part 724, when displaying a background image, a weather information image, or a clock information image.

As described above, by separating the Android extension part 724 and the Android open source part 722, the complexity of the platform is reduced, and only the relevant part may be updated or upgraded, when updating.

Meanwhile, the home appliance common extension part 725 may be a framework that may be commonly applied to a plurality of home appliances. Accordingly, various types of home appliances may be operated based on a common platform. Furthermore, by applying a common platform to home appliances, updates or upgrades may be performed efficiently.

The product extension part 728 may be a framework for a specific product among home appliances.

For example, if the home appliance is an air conditioner, the product extension part 728 may be utilized when controlling or setting a temperature.

As another example, if the home appliance is a washing machine, the product extension part 728 may be utilized when performing washing operation or setting a washing course.

As described above, by separating the home appliance common extension part 725 and the product extension part 728, the complexity of the platform is reduced, and only the relevant part may be updated or upgraded, when updated.

Meanwhile, the application 708 may be separated into an application 732 based on the Android open source part 722, an application 734 based on the Android extension part 734, an application 735 based on the home appliance common extension part 725, and an application 738 based on the product extension part 728.

Accordingly, the complexity of the platform is reduced, and only the relevant part may be updated or upgraded, when updated.

For example, the application 732 based on the Android open source part 722 may include a photo album application, a web browser application, a map application, a video streaming application, or the like.

Meanwhile, the application 734 based on the Android extension part 734 may include a home screen application, a clock widget, or a weather widget.

Meanwhile, the application 735 based on the home appliance common extension part 725 may include a setting screen application or a remote control screen application.

Meanwhile, the application 738 based on the product extension part 728 may include a temperature control application, etc. when the home appliance is an air conditioner.

As another example, the application 738 based on the product extension part 728 may include a washing course setting application, etc. when the home appliance is a washing machine.

FIG. 8 is a diagram illustrating another example of a platform executed on a processor in a home appliance according to an embodiment of the present disclosure.

Referring to FIG. 8, the home appliance 200 may exchange data with the mobile terminal 600 through the server 500, or operate based on an IR signal or RF signal of the remote control device 100.

For example, the home appliance 200 may perform Infrared Data Association (IrDA) communication with the remote control device 100 based on an IR signal.

Meanwhile, the home appliance 200 may perform a Bluetooth (BT) or low-power Bluetooth (BLE) communication with the remote control device 100, based on an RF signal.

Meanwhile, the home appliance 200 may perform a wireless communication based on WiFi or a wired communication based on Ethernet with the server 500 or the mobile device 600.

Meanwhile, the processor 770 within the home appliance 200 may be configured to execute a platform based on Linux or Android.

That is, the processor 770 within the home appliance 200 may be configured to execute an operating system kernel 800 based on Linux or Android.

Meanwhile, the operating system kernel 800 may include a device driver 820.

The device driver 820 may include an audio device driver, an IPC driver, a display driver, a keypad driver, a Bluetooth communication driver, a camera driver, a memory driver, a USB driver, or a Wi-Fi driver.

Meanwhile, the processor 770 within the home appliance 200 can execute power management 810 separately from the operating system kernel 800. Accordingly, a power supply unit that supplies power to the home appliance 200 may be controlled.

Meanwhile, unlike the drawing, it is also possible that the power management 810 is included in the operating system kernel 800.

Meanwhile, the processor 770 in the home appliance 200 may be configured to execute a hardware abstraction layer 830 on the operating system kernel 800.

For example, the hardware abstraction layer 830 may include an audio device abstraction layer, a Bluetooth device abstraction layer, a camera device abstraction layer, a sensor device abstraction layer, or the like.

Meanwhile, the processor 770 in the home appliance 200 may be configured to execute a library 840 and an Android runtime 850 on the hardware abstraction layer 830.

Meanwhile, the processor 770 in the home appliance 200 may be configured to execute a framework 860 on the library 840 and the Android runtime 850.

Meanwhile, the framework 860 may include an Android extension part 724, a content provider 862, a view system 864, a manager 867, and the like.

Meanwhile, the processor 770 in the home appliance 200 may be configured to execute an application 870 on the framework 860.

For example, the application 870 may include a calendar application, a camera application, etc.

Meanwhile, the operating system kernel 800 of FIG. 8 corresponds to the operating system kernel 712 of FIG. 7, the hardware abstraction layer 830 of FIG. 8 corresponds to the hardware abstraction layer 714 of FIG. 7, the framework 860 of FIG. 8 corresponds to the framework 705 of FIG. 7, and the application 870 of FIG. 8 corresponds to the application 708 of FIG. 7.

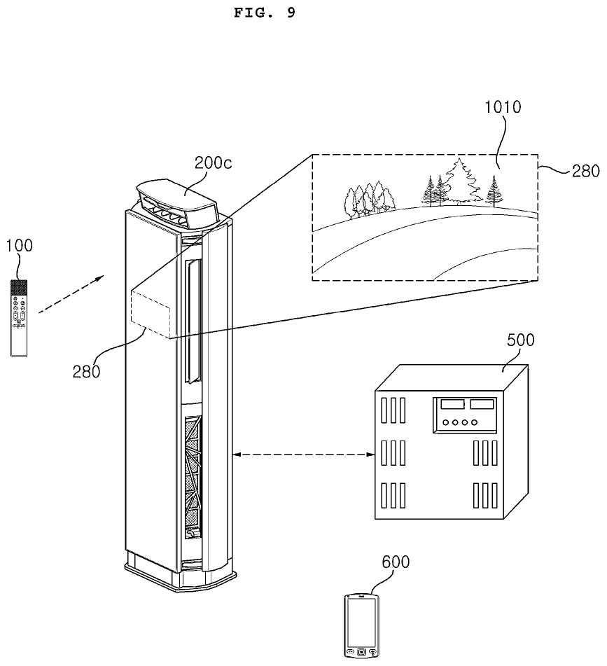

FIG. 9 is a diagram illustrating an air conditioner which is an example of a home appliance according to an embodiment of the present disclosure.

Referring to FIG. 9, an air conditioner 200c, which is an example of the home appliance 200 according to an embodiment of the present disclosure, is powered on or operates by the remote control device 100, and may exchange data with the external server 500 or the mobile terminal 600.

Meanwhile, the air conditioner 200c, which is an example of the home appliance 200 according to an embodiment of the present disclosure, may include a display 280, and display a certain image 1010 on the display 280.

For example, a processor 770 in the air conditioner 200c which is an example of the home appliance 200 according to an embodiment of the present disclosure may be configured to display an image received from the server 500 or the mobile terminal 600 on the display 280.

Specifically, the processor 770 in the air conditioner 200c, which is an example of the home appliance 200 according to an embodiment of the present disclosure, may be configured to display an image received from the server 500 or the mobile terminal 600 on the display 280, based on the framework 705, and display the information based on sensor data on the display 280, based on the hardware abstraction layer 714 and the framework 705.

Accordingly, the information based on the sensor data and the received image may be processed and displayed separately.

Meanwhile, the image received from the server 500 or the mobile terminal 600 may include a weather information image, a clock information image, or a background image 1010.

For example, the processor 770 in the air conditioner 200c, which is an example of the home appliance 200 according to an embodiment of the present disclosure, may be configured to display a background image 1010 received from the server 500 or the mobile terminal 600, in a background screen display mode. At this time, the background image 1010 may be an art wall image.

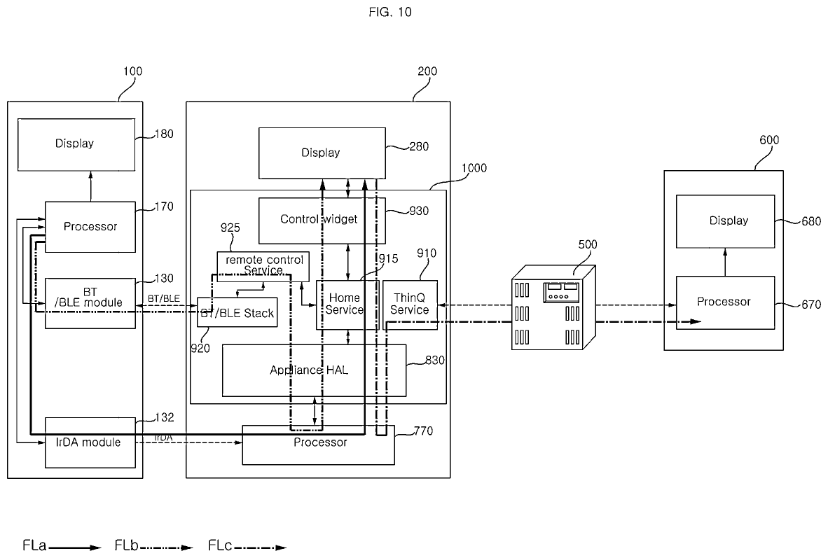

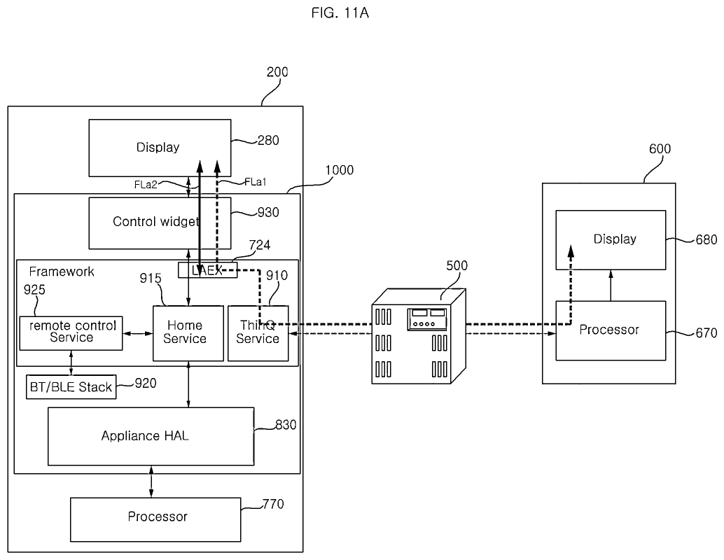

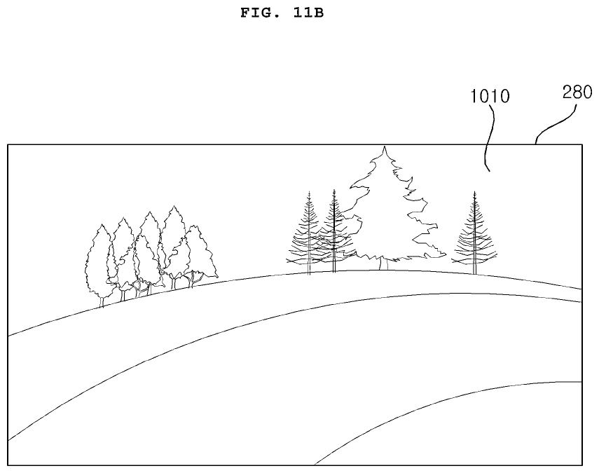

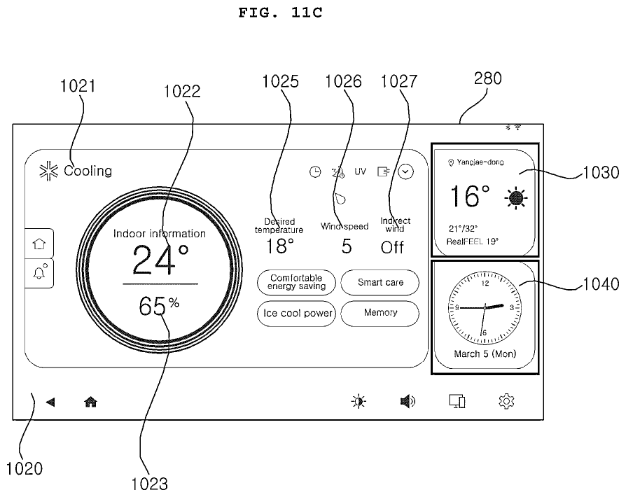

FIGS. 10 to 12B are diagrams for explaining the operation of a home appliance according to an embodiment of the present disclosure.

FIG. 10 is a diagram illustrating remote control by various communications of the home appliance.

Referring to FIG. 10, the home appliance 200 is equipped with the processor 770 and the display 20, receives a remote control signal from the remote control device 100, and exchanges data with the mobile terminal 600 through the server 500, etc.

Meanwhile, the remote control device 100 may include a display 180, a processor 170, an RF communication unit 130, and an IR communication unit 132.

Meanwhile, the mobile terminal 600 may include a processor 670 and a display 680.

Meanwhile, the processor 770 of the home appliance 200 may be configured to execute a platform 1000 based on the operating system kernel 712 of FIG. 7.

The platform 1000 may include an operating system kernel 712, a hardware abstraction layer 830 on the operating system kernel 712, a framework on the hardware abstraction layer 830, and an application on the framework.

That is, the processor 770 of the home appliance 200 may be configured to execute the operating system kernel 712, the hardware abstraction layer 830 on the operating system kernel 712, the framework 705 on the hardware abstraction layer 830, and the application on the framework 705.

For example, the framework 705 may include a server communication service 910, a home screen service 915, a remote control device service 925, etc.

For example, the application on the framework 705 may include a control widget 930, etc.

Meanwhile, when a remote control signal based on an IR signal is received from the remote control device 100, the display 280 may be controlled, by a first path FLa, via the processor 770, the hardware abstraction layer 830, the home screen service 915, the control widget 930, etc.

For example, in response to receiving a remote control signal based on Infra Red (IR) signal from the remote control device 100, the processor 770 may be configured to turn on the display 280, based on the hardware abstraction layer 714.

As another example, in response to receiving a remote control signal based on Infra Red (IR) signal from the remote control device 100, the processor 770 may be configured to execute a home screen service 915 within the framework 705, and control to display a home screen based on the hardware abstraction layer 714 and the home screen service 915. Accordingly, the home screen may be simply displayed based on the remote control signal.

Meanwhile, in response to receiving a remote control signal Radio Frequency (RF) signal from the remote control device 100, the processor 770 may control the display 280 via a RF communication service 920, a remote control device 925, service a hardware abstraction layer 830, a home screen service 915, a control widget 930, etc., by a second path FLb.

For example, in response to receiving a remote control signal Radio Frequency (RF) signal from the remote control device 100, the processor 770 may be configured to execute the remote control device service 925 and the home screen service 915 within the framework 705, and control to display the home screen, based on the hardware abstraction layer 714, the remote control device service 925, and the home screen service 915. Accordingly, the home screen may be simply displayed based on the remote control signal.

Meanwhile, when a remote control signal is received from the server 500 or the mobile terminal 600, the processor 770 may be configured to control the display 280 via the server communication service 910, the hardware abstraction layer 830, the home screen service 915, the control widget 930, etc., by a third path FLc.

For example, when a remote control signal is received from the server 500 or the mobile terminal 600, based on the server communication service 910 executed within the framework 705, the processor 770 may be configured to execute the home screen service 915 within the framework 705 and control to display the home screen, based on the hardware abstraction layer 714 and the home screen service 915.

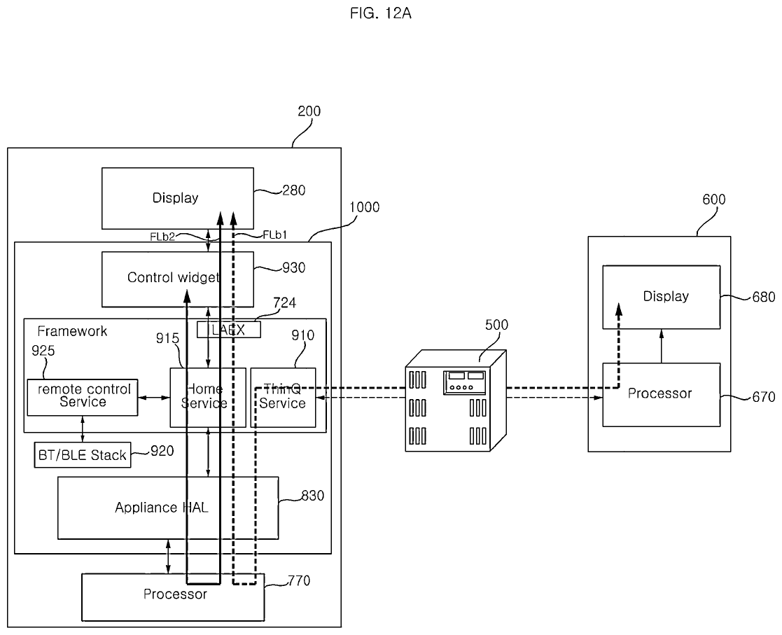

FIG. 11A is a diagram illustrating an example of the operation of a home appliance according to an embodiment of the present disclosure, FIG. 11B is an example of a background image, and FIG. 11C is an example of a home screen image.

Referring to the drawings, the processor 770 within the home appliance 200 according to an embodiment of the present disclosure may receive data from the server 500 or the mobile terminal 600, based on the server communication service 910 executed within the framework 705.

For example, the processor 770 may be configured to, in the background screen display mode, execute the server communication service 910 within the framework 705, receive a background image 1010 from the server 500 or the mobile terminal 600 through the server communication service 910, and control the display 280 to display the background image 1010 through the Android extension part 724, as shown in FIG. 10B.

As described above, the background image 1010 may be simply displayed, by displaying the background image 1010 on the display 280, through the server communication service 910 and the Android extension part 724 within the framework, without going through the hardware abstraction layer 714.

As another example, the processor 770 may be configured to, in the home screen display mode, execute the server communication service 910 and the home screen service 915 within the framework 705, receive a weather information image 1030 or a clock information image 1040 from the server 500 or the mobile terminal 600 through the server communication service 910, and display the weather information image 1030 or the clock information image 1040 in a certain area of the home screen 1020 displayed on the display 280, as shown in FIG. 11c, through the home screen service 915 and the Android extension part 724.

As described above, the weather information image 1030 or the clock information image 1040 may be simply displayed, by displaying the weather information image 1030 or the clock information image 1040 on the display 280, through the server communication service 910 and the Android extension part 724 within the framework, without going through the hardware abstraction layer 714.

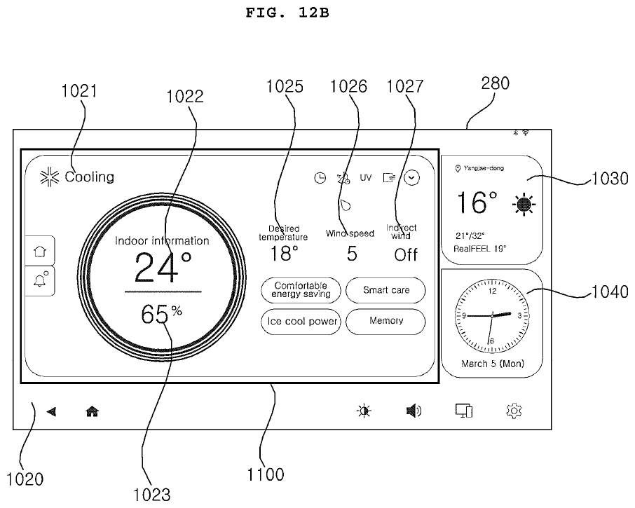

FIG. 12A is a drawing illustrating another example of the operation of a home appliance according to an embodiment of the present disclosure, and FIG. 12B is an example of a home screen image.

Referring to the drawing, the processor 770 within the home appliance 200 may receive sensor data from the sensor device 285.

Meanwhile, the processor 770 may be configured to, in the home screen display mode, execute the home screen service 915 within the framework 705, and display the information based on the sensor data on the display 280, through the hardware abstraction layer 714, the home screen service 915, and the Android extension part 724.

Meanwhile, the processor 770 may be configured to, in the home screen display mode, execute the server communication service 910 and the home screen service 915 within the framework 705, receive the weather information image 1030 or the clock information image 1040 from the server 500 or the mobile terminal 600 through the server communication service 910, and display the weather information image 1030 or the clock information image 1040 in a certain area of the home screen 1020 displayed on the display 280, as shown in FIG. 11C, through the home screen service 915 and the Android extension part 724.

In particular, in the home screen display mode, the processor 770 may be configured to display the information based on sensor data in a first area which is the left area of the home screen 1020, and display the weather information image 1030 or clock information image 1040 received from the server 500 or the mobile terminal 600 in a second area which is the right area of the home screen 1020. Accordingly, the information based on the sensor data and the received image may be processed and displayed separately.

Meanwhile, temperature information 1022 based on temperature data from the sensor device 285 and humidity information 1023 based on humidity data may be displayed in the first area which is the left area of the home screen 1020. Accordingly, intuitive recognition of temperature information or humidity information becomes possible.

Meanwhile, input information or state information may be further displayed in the first area which is the left area of the home screen 1020.

For example, cooling information 1021, desired temperature information 1025, wind speed information 1026, indirect wind information 1027, etc. which are current state may be further displayed in the first area, which is the left area in the home screen 1020. Accordingly, intuitive recognition of various input information or state information, etc. is possible.

Meanwhile, when displaying the home screen, the processor 770 may be configured to display the second area based on the image received from the server 500 or mobile terminal 600 first, rather than the first area based on sensor data.

Since the first area based on sensor data passes through the hardware abstraction layer 714, etc., the second area based on image that does not pass through the hardware abstraction layer 714, etc. may be displayed first.

Meanwhile, comparing FIG. 11B and FIG. 12B, in the background screen display mode, the processor 770 may be configured to display the background image 1010 received from the server 500 or the mobile terminal 600, as in FIG. 11B, and, in the home screen display mode, may be configured to display the information based on sensor data on the display 280, as in FIG. 12B. Accordingly, the information based on the sensor data and the received image may be processed and displayed separately.

Meanwhile, the processor 770 described in FIG. 7 to FIG. 12B may be arranged in various locations within the home appliance 200.

For example, the processor 770 described in FIG. 7 to FIG. 12B may be arranged in the second circuit PBc of FIG. 5C. Specifically, the processor 270c of FIG. 5C may correspond to the processor 770 described in FIGS. 7 to 12B.

That is, the load driver 245 may be arranged in the first circuit PBa, and the transceiver 222 and the processor 770 may be arranged in the second circuit PBc. Accordingly, the load control and the driving mode control executed based on the operating system may be separated, and further, efficient updates may be enabled.

As another example, the processor 770 described in FIGS. 7 to 12B may be arranged in the third circuit PBb of FIG. 5A. Specifically, the processor 270b of FIG. 5A may correspond to the processor 770 described in FIGS. 7 to 12B.

That is, the load driver 245 is arranged in the first circuit PBa, the transceiver 222 is arranged in the second circuit PBc, the processor 770 is arranged in the third circuit PBb, and the second circuit PBc may be arranged between the first circuit PBa and the third circuit PBb. Accordingly, the load control and the driving mode control executed based on the operating system are separated, thereby enabling efficient updates.

As another example, the processor 770 described in FIGS. 7 to 12B may be arranged in the second circuit PBc of FIG. 5A. Specifically, the processor 270c of FIG. 5A may correspond to the processor 770 described in FIGS. 7 to 12B.

As another example, the processor 770 described in FIGS. 7 to 12B may be arranged in the third circuit PBb of FIG. 5B. Specifically, the processor 270b of FIG. 5B may correspond to the processor 770 described in FIGS. 7 to 12B.

Meanwhile, the load driver 245 is arranged in the first circuit PBa, the second processor 270c controlling the driving mode is arranged in the second circuit PBc, the transceiver 222 and the processor 770 are arranged in the third circuit PBb, and the second circuit PBc may be arranged between the first circuit PBa and the third circuit PBb. Accordingly, the load control and driving mode control executed based on the operating system are separated, thereby enabling efficient updates.

As another example, the processor 770 described in FIGS. 7 to 12B may be arranged in the second circuit PBc of FIG. 5B. Specifically, the processor 270c of FIG. 5B may correspond to the processor 770 described in FIGS. 7 to 12B.

As described above, in accordance with an aspect of the present disclosure, a home appliance includes: a display; a transceiver configured to receive data from an external server or a mobile terminal; a load driver configured to perform load control or safety control; a processor configured to display a home screen including information based on sensor data from a sensor device on the display, in which the processor is configured to execute an operating system kernel, execute a hardware abstraction layer on the operating system kernel, execute a framework on the hardware abstraction layer, execute an application on the framework, display an image received from the server or the mobile terminal on the display, based on the framework, and display the information based on the sensor data on the display, based on the hardware abstraction layer and the framework. Accordingly, it is possible to process and display the information based on the sensor data and the received image separately. Therefore, it is possible to simply display a background screen or home screen.

Meanwhile, the image received from the server or the mobile terminal may include a weather information image, a clock information image, or a background image. Accordingly, it is possible to process and display the information based on the sensor data and the received image separately.

Meanwhile, the processor may be configured to, in a background screen display mode, display a background image received from the server or the mobile terminal, and in a home screen display mode, display the information based on the sensor data on the display. Accordingly, it is possible to process and display the information based on the sensor data and the received image separately.

Meanwhile, the processor may be configured to, in a home screen display mode, display the information based on the sensor data on a first area within the home screen, and display a weather information image or clock information image received from the server or the mobile terminal on a second area within the home screen. Accordingly, it is possible to process and display the information based on the sensor data and the received image separately.

Meanwhile, the processor may be configured to, in the framework, execute an Android open source part, an Android extension part, a home appliance common extension part, and a product extension part, separately. Accordingly, various types of home appliances can be operated based on a common platform. Furthermore, updates or upgrades can be performed efficiently by applying a common platform to home appliances.

Meanwhile, the processor may be configured to, in a background screen display mode, execute a server communication service within the framework, receive a background image from the server or the mobile terminal through the server communication service, and display the background image on the display through the Android extension part. Accordingly, it is possible to process and display the information based on the sensor data and the received image separately.

Meanwhile, the processor may be configured to, in a home screen display mode, execute a server communication service and a home screen service within the framework, receive a weather information image or a clock information image from the server or the mobile terminal through the server communication service, and display the weather information image or the clock information image on the display through the home screen service and the Android extension part. Accordingly, it is possible to process and display the information based on the sensor data and the received image separately.

Meanwhile, the processor may be configured to, in a home screen display mode, execute a home screen service within the framework, and display the information based on the sensor data on the display, through the hardware abstraction layer, the home screen service, and the Android extension part. Accordingly, it is possible to process and display the information based on the sensor data and the received image separately.

Meanwhile, the processor may be configured to, in response to receiving a remote control signal based on Infra Red (IR) signal from a remote control device, turn on the display, based on the hardware abstraction layer. Accordingly, the display can be turned on based on a remote control signal.

Meanwhile, the processor may be configured to, in response to receiving a remote control signal based on Infra Red (IR) signal from a remote control device, execute a home screen service within the framework, and display the home screen, based on the hardware abstraction layer and the home screen service. Accordingly, the home screen can be simply displayed based on a remote control signal.

Meanwhile, the processor may be configured to, in response to receiving a remote control signal Radio Frequency (RF) signal from a remote control device, execute a remote control device service and a home screen service within the framework, and display the home screen, based on the hardware abstraction layer, the remote control device service, and the home screen service. Accordingly, the home screen can be simply displayed based on a remote control signal.

Meanwhile, in response to receiving a remote control signal from the server or the mobile terminal, based on a server communication service executed within the framework, the processor may be configured to execute a home screen service within the framework, and display the home screen, based on the hardware abstraction layer, and the home screen service. Accordingly, the home screen can be simply displayed based on a remote control signal.

Meanwhile, the processor may be configured to execute a board support package including the operating system kernel, the hardware abstraction layer, and a device driver, execute the framework on the board support package, and execute an application on the framework. Accordingly, it is possible to process and display the information based on the sensor data and the received image separately.

Meanwhile, the processor may be further configured to execute a boot loader within the board support package. This enables quick booting.

Meanwhile, the load driver may be arranged in a first circuit, and the transceiver and the processor are arranged in a second circuit. Accordingly, efficient updates are possible by separating the load control and the operating mode control that is executed based on the operating system.

Meanwhile, the load driver may be arranged in a first circuit, the transceiver may be arranged in a second circuit, the processor may be arranged in a third circuit, and the second circuit may be arranged between the first circuit and the third circuit. Accordingly, efficient updates are possible by separating the load control and the operating mode control that is executed based on the operating system.

Meanwhile, the load driver may be arranged in a first circuit, a second processor configured to control an operation mode may be arranged in a second circuit, the transceiver and the processor may be arranged in a third circuit, and a second circuit may be arranged between the first circuit and the third circuit. Accordingly, efficient updates are possible by separating the load control and the operating mode control that is executed based on the operating system.

In accordance with another aspect of the present disclosure, a home appliance includes: a display; a transceiver configured to receive data from an external server or a mobile terminal; a load driver configured to perform load control or safety control; a processor configured to display a home screen including information based on sensor data from a sensor device on the display, in which the processor is configured to execute an operating system kernel, execute a framework on the operating system kernel, execute an application on the framework, and execute an Android open source part, an Android extension part, a home appliance common extension part, and a product extension part within the framework separately. Accordingly, various types of home appliances can be operated based on a common platform. Furthermore, updates or upgrades can be performed efficiently by applying a common platform to home appliances.

Meanwhile, the processor may be configured to, in a background screen display mode, execute a server communication service within the framework, receive a background image from the server or the mobile terminal through the server communication service, and display the background image on the display through the Android extension part. Accordingly, it is possible to process and display the information based on the sensor data and the received image separately.

Meanwhile, the processor may be configured to, in a home screen display mode, execute a server communication service and a home screen service within the framework, receive a weather information image or a clock information image from the server or the mobile terminal through the server communication service, and display the weather information image or the clock information image on the display through the home screen service and the Android extension part. Accordingly, it is possible to process and display the information based on the sensor data and the received image separately.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

What is claimed is:

1. A home appliance comprising:
a display;
a transceiver configured to receive data from an external server or a mobile terminal;
a load driver configured to perform load control or safety control;
a processor configured to display a home screen including information based on sensor data from a sensor device on the display,
wherein the processor is configured to:
execute an operating system kernel, execute a hardware abstraction layer on the operating system kernel, execute a framework on the hardware abstraction layer, execute an application on the framework,
display an image received from the server or the mobile terminal on the display, based on the framework, and
display the information based on the sensor data on the display, based on the hardware abstraction layer and the framework.

2. The home appliance of claim 1, wherein the image received from the server or the mobile terminal comprises a weather information image, a clock information image, or a background image.

3. The home appliance of claim 1, wherein the processor is configured to:
in a background screen display mode, display a background image received from the server or the mobile terminal, and
in a home screen display mode, display the information based on the sensor data on the display.

4. The home appliance of claim 1, wherein the processor is configured to, in a home screen display mode, display the information based on the sensor data on a first area within the home screen, and display a weather information image or clock information image received from the server or the mobile terminal on a second area within the home screen.

5. The home appliance of claim 1, wherein the processor is configured to, in the framework, execute an Android open source part, an Android extension part, a home appliance common extension part, and a product extension part, separately.

6. The home appliance of claim 5, wherein the processor is configured to, in a background screen display mode, execute a server communication service within the framework, receive a background image from the server or the mobile terminal through the server communication service, and display the background image on the display through the Android extension part.

7. The home appliance of claim 5, wherein the processor is configured to, in a home screen display mode, execute a server communication service and a home screen service within the framework, receive a weather information image or a clock information image from the server or the mobile terminal through the server communication service, and display the weather information image or the clock information image on the display through the home screen service and the Android extension part.

8. The home appliance of claim 5, wherein the processor is configured to, in a home screen display mode, execute a home screen service within the framework, and display the information based on the sensor data on the display, through the hardware abstraction layer, the home screen service, and the Android extension part.

9. The home appliance of claim 1, wherein the processor is configured to, in response to receiving a remote control signal based on Infra Red (IR) signal from a remote control device, turn on the display, based on the hardware abstraction layer.

10. The home appliance of claim 1, wherein the processor is configured to, in response to receiving a remote control signal based on Infra Red (IR) signal from a remote control device, execute a home screen service within the framework, and display the home screen, based on the hardware abstraction layer and the home screen service.

11. The home appliance of claim 1, wherein the processor is configured to, in response to receiving a remote control signal Radio Frequency (RF) signal from a remote control device, execute a remote control device service and a home screen service within the framework, and display the home screen, based on the hardware abstraction layer, the remote control device service, and the home screen service.

12. The home appliance of claim 1, wherein, in response to receiving a remote control signal from the server or the mobile terminal, based on a server communication service executed within the framework, the processor is configured to execute a home screen service within the framework, and display the home screen, based on the hardware abstraction layer, and the home screen service.

13. The home appliance of claim 1, wherein the processor is configured to execute a board support package including the operating system kernel, the hardware abstraction layer, and a device driver, execute the framework on the board support package, and execute an application on the framework.

14. The home appliance of claim 13, wherein the processor is further configured to execute a boot loader within the board support package.

15. The home appliance of claim 13, wherein the load driver is arranged in a first circuit, and the transceiver and the processor are arranged in a second circuit.

16. The home appliance of claim 13, wherein the load driver is arranged in a first circuit,
the transceiver is arranged in a second circuit,
the processor is arranged in a third circuit, and
the second circuit is arranged between the first circuit and the third circuit.

17. The home appliance of claim 13, wherein the load driver is arranged in a first circuit,
a second processor configured to control an operation mode is arranged in a second circuit,
the transceiver and the processor are arranged in a third circuit, and
a second circuit is arranged between the first circuit and the third circuit.

18. A home appliance comprising:
a display;
a transceiver configured to receive data from an external server or a mobile terminal;
a load driver configured to perform load control or safety control;
a processor configured to display a home screen including information based on sensor data from a sensor device on the display,
wherein the processor is configured to execute an operating system kernel, execute a framework on the operating system kernel, execute an application on the framework, and
execute an Android open source part, an Android extension part, a home appliance common extension part, and a product extension part within the framework separately.

19. The home appliance of claim 18, wherein the processor is configured to, in a background screen display mode, execute a server communication service within the framework, receive a background image from the server or the mobile terminal through the server communication service, and display the background image on the display through the Android extension part.

20. The home appliance of claim 18, wherein the processor is configured to, in a home screen display mode, execute a server communication service and a home screen service within the framework, receive a weather information image or a clock information image from the server or the mobile terminal through the server communication service, and display the weather information image or the clock information image on the display through the home screen service and the Android extension part.
